(19) United States
(12) Patent Application Publication
(10) Pub. No.: US 2009/0016360 A1
(43) Pub. Date: Jan. 15, 2009

(54) STORAGE MEDIA STORING A NETWORK RELAY CONTROL PROGRAM, APPARATUS, AND METHOD

(75) Inventor: Toshihiko KURITA, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/169,522

(22) Filed: Jul. 8, 2008

(30) Foreign Application Priority Data
Jul. 9, 2007 (JP) 2007-179287

(51) Int. Cl. H04L 12/56

(52) U.S. Cl. 370/397

(57) ABSTRACT

A judging unit in a network relay apparatus for communicating between first and second networks determines whether a first address in the first network and a second address in the second network overlap. If so, a determining unit finds a third address range and a fourth address range to avoid the overlap. The third address range is a private address range used by a communication device within the first network to identify a communication device within the second network, and the fourth address range is a private address range used by a communication device within the second network to identify a communication device within the first network.

### TECHNICAL FIELD

The present invention relates to network relay control for enabling tunneling communication among a plurality of networks.

### BACKGROUND OF THE INVENTION

Using an external business information service (e.g., other companies, including Application Service Providers (ASP)) has become popular. Under these circumstances, a plurality of sites of a Local Area Network (LAN) needs to be connected securely. In order to achieve this, a tunneling system (encapsulated transfer, for example, by IPsec or IPinIP) is set between sites.

When each site has a private address space under different management, IP addresses of devices to be connected can overlap. In this case, these devices can not directly communicate with each other, so a measure to avoid overlapping IP address is required.

Known methods to avoid overlapping IP addresses are as follows;

Method A: IP addresses are manually reset so that the addresses are not overlapped.

Method B: Network Address Translation (NAT) is used at a router.

Method C: All devices used should be IPv6 compatible. No address overlap will occur by using automatically generated IPv6 global addresses.

Methods A and C will have a substantial effect on system performance, and are not desirable to apply to a large scale network. Next, Method B will be explained.

FIG. 15 is a block diagram illustrating a conventional configuration of a tunneling communication system. The tunneling communication system provides a base 1 which is a site (private network), and a center 2 which is another site, WAN 3 (Wide Area Network or Internet), a tunnel server 4, and DNS 7 (Domain Name Server). The base 1 has a router 11a and a client 12. The center 2 has a router 11b and a server 13. The client 12 can be connected to WAN3 via the router 11a. The server 13 can be connected to WAN 3 via the router 11b. The tunnel server 4 and DNS 7 are connected to WAN3.

The private address range in the base 1 is 192.168.1.0/24 (indicates a range from 192.168.1.0 to 192.168.1.255) and that in the center 2 is 192.168.1.0/24. The private address of the client 12 is 192.168.1.1 and that of the server 13 is 192.168.1.1. The global address of the tunnel server 4 is 192.168.50.20. The global address of the DNS7 is 192.168.50.10. The private address of the router 11a is 192.168.1.10 and that of the router 11b is 192.168.1.10. The global address of the router 11a is 192.168.30.10 and that of the router 11b is 192.168.40.10.

Next, an operation of a conventional tunneling system will be explained.

(S1) The tunnel server 4 statically or dynamically sets a tunnel between sites.

(S2) Using DNS 7, the client 12 searches for a global address of the server 13 with which the client 12 communicates.

(S3) The client 12 transmits a packet the destination of which is the server 13 (SrcIP (Source) IP address=Private address of the client 12 (192.168.1.1), DstIP (Destination) IP address)=Global address of the server 13).

(S4) The router 11a translates SrcIP from the private address to the global address by NAT (SrcIP=global address of the client 12, DstIP=global address of the server 13).

(S5) The router 11a and the router 11b perform tunneling by Tunnel IF in WAN 3. The packet here is encapsulated by the router 11a (SrcIP=Global address of the router 11a (192.168.30.10), DstIP=Global address of the router 11b (192.168.40.10)), and decapsulated by the router 11b (SrcIP=Global address of the client 12, DstIP=Global address of the server 13).

(S6) The router 11b translates DstIP from the global address to the private address by NAT (SrcIP=global address of the client 12, DstIP=private address of the server 13)

(S7) The server 13 receives the packet and completes this sequence.

As a conventional technology related to this invention, there is a gateway translating a preset virtual private address into a real private address (e.g. Japanese Laid-open Patent Publication No. 2000-228674) for individual Virtual Private Network (VPN) connection between a client and Gateway (GW). Other conventional technology includes a gateway which sets virtual private addresses when private addresses overlap and translates the virtual private address into a real private address for connection between private networks (e.g. Japanese Laid-open Patent Publication No. 2003-152767).

### SUMMARY

A judging unit in a network relay apparatus for communicating between first and second networks determines whether a first address in the first network and a second address in the second network overlap. If so, a determining unit finds a third address range and a fourth address range to avoid the overlap. The third address range is a private address range used by a communication device within the first network to identify a communication device within the second network, and the fourth address range is a private address range used by a communication device within the second network to identify a communication device within the first network.

### BRIEF DESCRIPTION OF THE DRAWING

FIG. 1 is a block diagram illustrating a system configuration of the tunneling communication system according to the first embodiment of the present invention.

FIG. 2 is a block diagram illustrating a router configuration according to the first embodiment of the present invention.

FIG. 3 is a block diagram illustrating a configuration of a tunneling server according to the first embodiment of the present invention.

FIG. 4 is a sequence diagram illustrating an operation performed when address overlap exists in the tunneling communication system according to the first embodiment of the present invention.

FIG. 5 is a schematic diagram illustrating an address mapping according to the first embodiment of the present invention.

FIG. 6 is a table showing a conventional NAT table and a NAT table according to the first embodiment of the present invention.

FIG. 7 is a sequence diagram illustrating an operation when no address overlap exists in the tunneling communication system according to the first embodiment of the present invention.

FIG. 8 is a sequence diagram illustrating an operation when address overlap exists in the tunneling communication system according to the second embodiment of the present invention.

FIG. 9 is a block diagram illustrating a system configuration of the tunneling communication system according to the third embodiment of the present invention.

FIG. 10 is a sequence diagram illustrating an operation performed when address overlap exists in the tunneling communication system according to the third embodiment of the present invention.

FIG. 11 is a block diagram illustrating a system configuration of the tunneling communication system according to the fourth embodiment of the present invention.

FIG. 12 is a block diagram illustrating a router configuration according to the fourth embodiment of the present invention.

FIG. 13 is a sequence diagram illustrating an operation performed when address overlap exists in the tunneling communication system according to the fourth embodiment of the present invention.

FIG. 14 is a sequence diagram illustrating an operation when no address overlap exists in the tunneling communication system according to the fourth embodiment of the present invention.

FIG. 15 is a block diagram illustrating a conventional configuration of the tunneling communication system.

### DETAILED DESCRIPTION OF THE EMBODIMENT

### The First Embodiment

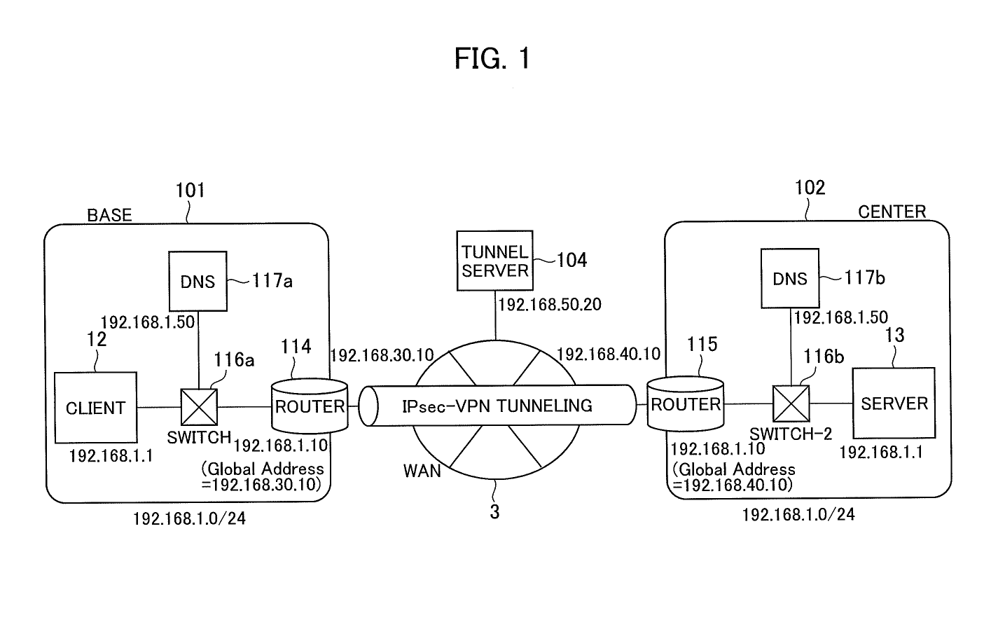

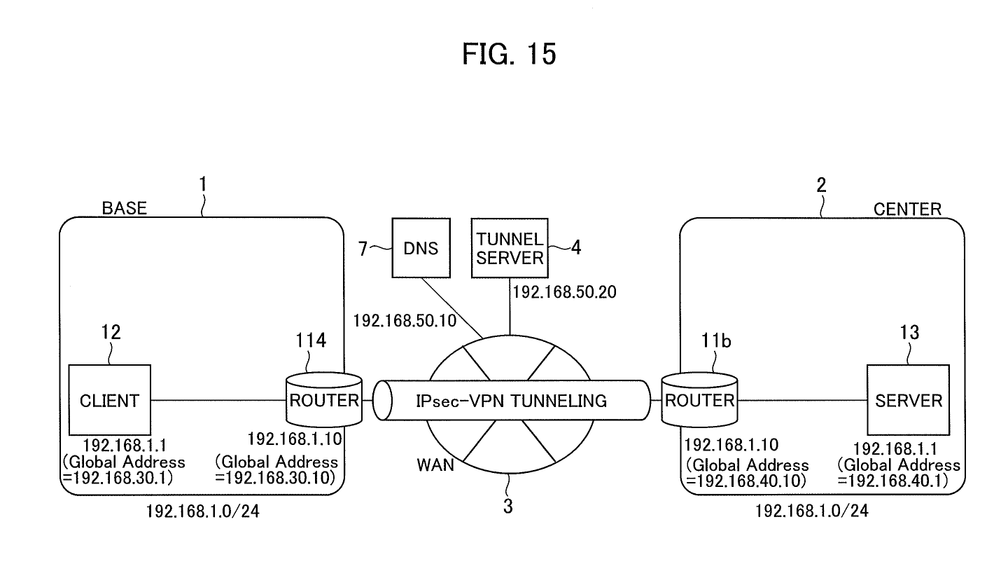

FIG. 1 is a block diagram illustrating a configuration of the tunneling communication system according to the first embodiment of the present invention. When a reference numeral in FIG. 1 is the same as that in FIG. 15, the numeral indicates the same or equivalent entity, thus the explanation is omitted here. FIG. 1 when compared with FIG. 15 has a base 101 (the first network) instead of the base 1, a center 102 (the second network) instead of the center 2, and a tunnel server 104 instead of the tunnel server 4 respectively. In FIG. 1, DNS 7 is not required. The base 101 when compared with the base 1, comprises a router 114 instead of the router 11a. The base 101a also comprises a DNS 117a and a switch 116a which the base 1 does not provide. The center 102 when compared with the center 2, comprises a router 115 instead of the router 11b. The center 102 also comprises a DNS 117b and a switch 116b which the center 2 does not provide.

The client 12, the router 114, and the DNS 117a, are connected via the switch 116a. The server 13, the router 115, and the DNS 117b are connected via the switch 116b.

In this embodiment, each site (the base 101 and the center 102) has its own DNS. The tunnel server 104 determines an address mapping when private address ranges between sites overlap. According to this embodiment, the tunnel server 104 statically builds a tunnel (a tunnel that is built before packet transmission).

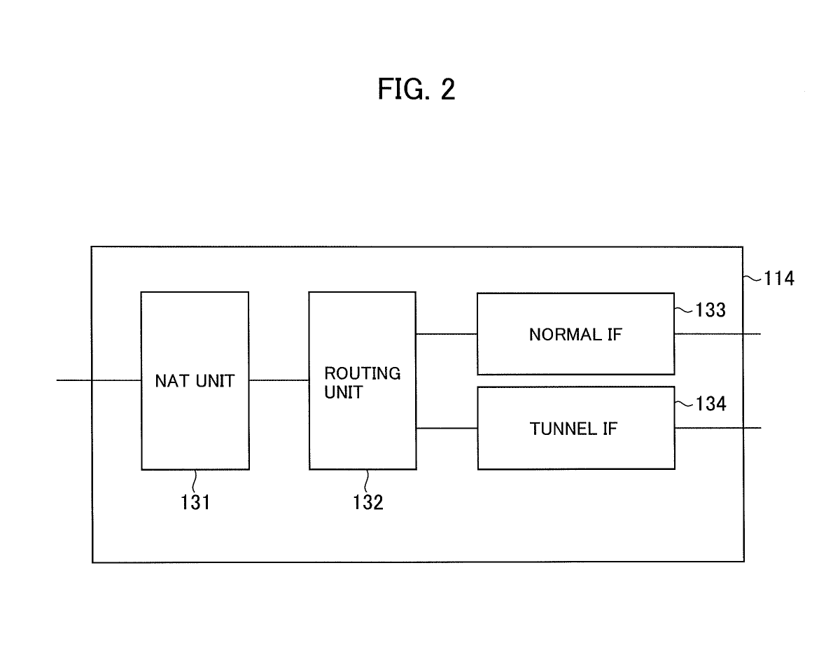

FIG. 2 is a block diagram illustrating a router configuration according to the first embodiment of the present invention. The router 114 (and the router 115) have a NAT unit 131, the routing unit 132, Normal IF (Interface) 133, and Tunnel IF 134. NAT unit 131 provides a NAT table and performs network address translation (NAT) between a LAN and a WAN. The routing unit 132 provides a routing table and performs routing to the LAN or WAN. Normal interface IF 133 communicates with a standard WAN which does not perform a tunneling process. The tunneling interface IF 134 performs a tunneling process (encapsulation of packets to a WAN, and decapsulation of packets from a WAN)

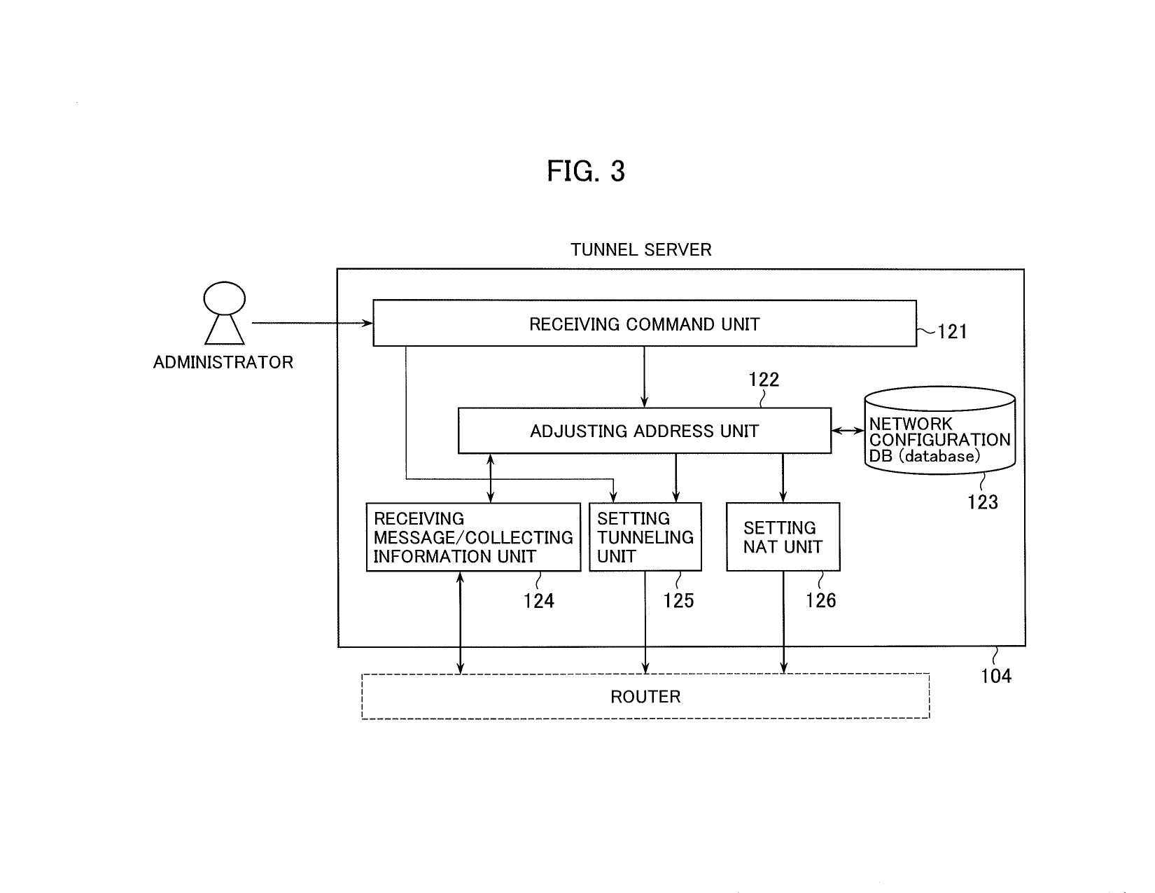

FIG. 3 is a block diagram illustrating a configuration of the tunneling server according to the first embodiment of the present invention. The tunnel server 104 includes a receiving command unit 121, an adjusting address unit 122, a network configuration DB (database) 123, a receiving message/collecting information unit 124, a setting tunnel unit 125, and a setting NAT unit 126.

The receiving command unit 121 receives a request for tunnel setting from an administrator and passes the request to the adjusting address unit 122 or the setting tunneling unit 125. The adjusting address unit 122 identifies the router 114 and the router 115 located in a tunneling setting interval by referring to the network configuration DB123. The adjusting address unit 122 examines the private address space of the router 114 and the router 115 via the receiving message/collecting information unit 124, and detects whether the acquired private address spaces are overlapped or not. The adjusting address unit 122 instructs the setting tunneling unit 125 to set a tunneling path, and instructs a setting NAT unit 126 to set one or more new network addresses when addresses overlap.

The network configuration DB 123 is a database having configuration information on network connection and also having global addresses of the router 114 and the router 115. The setting tunnel unit 125 sets tunneling (VPN) for the router 114 and 115. The setting NAT unit 126 sets the network address for the router 114.

An apparatus within the base 101 are called the base apparatus hereinafter, and an apparatus in the center 102 is called the center apparatus. A private address space used by the base apparatus is called the base address space, and the private address represented by base address space is called the base address. The private address space used by the center apparatus is called a center address space, and the private address represented by center address space is called the center address.

An address range of the base apparatus (e.g., client 12) in the base address space is assumed to be set as 192.168.1.0/24. Furthermore an address range of center apparatus (e.g., server 13) in the center address space is assumed to be set as 192.168.1.0/24. This means that the address range of the base apparatus in the base address space and that of the center apparatus in the center address space overlap.

The base address of the client 12 is 192.168.1.1 and the center address of the server 13 is 192.168.1.1. The global address of the tunnel server 104 is 192.168.50.20. The base address of the router 114 is 192.168.1.10, and the center address of the router 115 is 192.168.1.10. The global address of the router 114 is 192.168.30.10. The base address of the DNS 117a is 192.168.1.50 and the center address of the DNS117b is 192.168.1.50.

Next, operation when addresses overlap exists in the tunneling communication system according to this embodiment is explained.

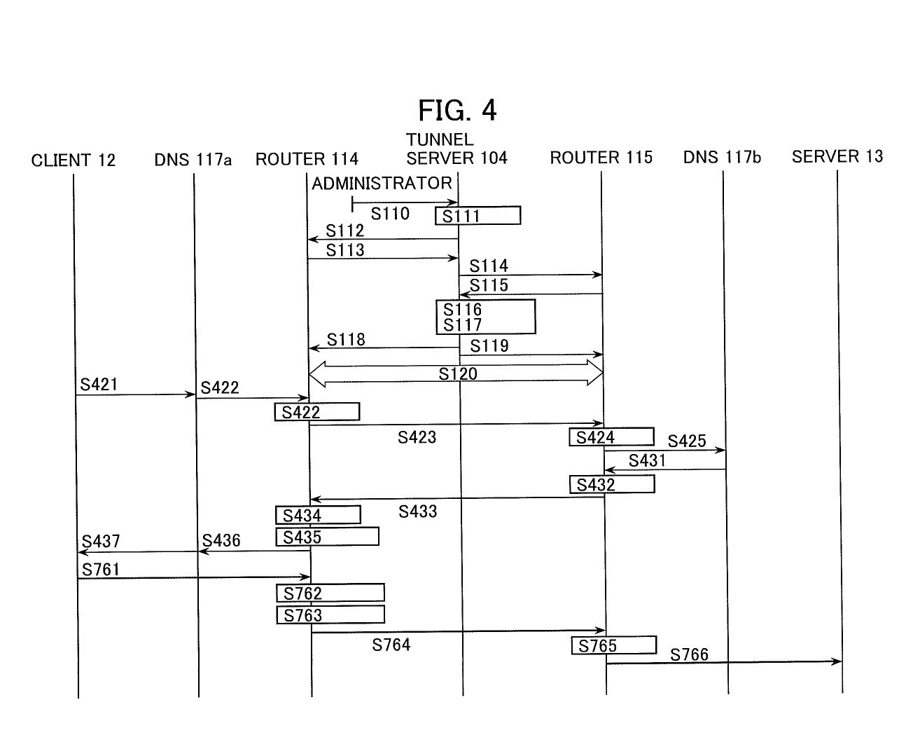

FIG. 4 is a sequence diagram illustrating an operation when address overlap exists in the tunneling communication system according to the embodiment of the present invention. The sequence diagram illustrates operation of the client 12, the DNS117a, the Router 114, the tunnel server 104, the router 115, the DNS117b, and the server 13.

First, the tunnel server 104 (the receiving command unit 121) receives a tunnel setting from an administrator (S110), and then identifies a connection router (S111).

Then the tunnel server 104 (the adjusting address unit 122) transmits an inquiry on private address space to the router 114 (S112). As the response, the router 114 transmits the base address space information to the tunnel server 104 (S113). The tunnel server 104 (adjusting address unit 122) transmits an inquiry on private address space to the router 115 (S114). As the response, the router 115 transmits center address space information to the tunnel server 104 (S115). Then the tunnel server 104 (adjusting address unit 122) compares information on received base address space and that on center address space to determine whether address overlap exists or not (S116).

When address overlap exists, the tunnel server 104 (the adjusting address unit 122) determines the address mapping so that addresses do not overlap (S117). Then the tunnel server 104 (the setting NAT unit 126) transmits a NAT instruction including the address mapping to the router 114 and the tunnel server 104 (the setting tunneling unit 125) transmits VPN building instruction to the router 114 (S118). Moreover, the tunnel server 104 (the setting tunneling unit 125) transmits VPN building instruction to the router 115 (S119). The router 114 and the router 115 which received the VPN building instruction builds VPN (IPsec-VPN) between the base 101 and the center 102 (S120).

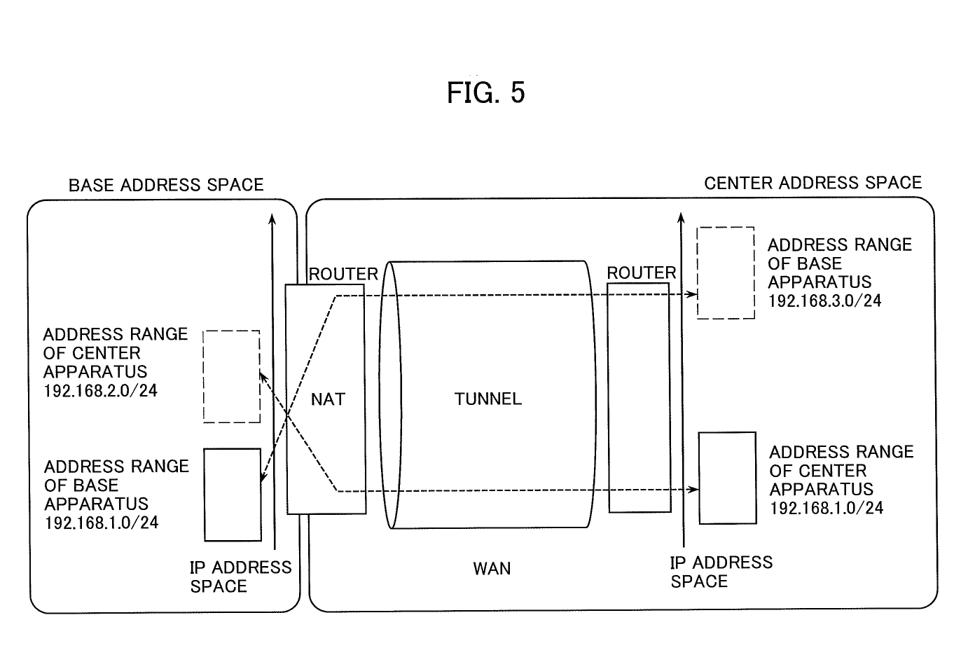

The address mapping determined by the tunnel server 104 will now be explained. FIG. 5 is a schematic diagram illustrating an address mapping according to the embodiment of the present invention. As mentioned above, the address range of the base apparatus in base address space and that of the center apparatus in center address space overlap.

At this time, the tunnel server 104, for example, sets an address range of 192.168.2.0/24, which does not overlap with the address range of the base apparatus in the base address space (available), as the address range of the center apparatus in the base address space. Moreover, the tunnel server 104 sets an address range of 192.168.3.0/24, which does not overlap with both address range of the center apparatus in center address space and that in the base address space, as address range of base apparatus in center address space.

As a result of this address mapping, the base apparatus identifies the IP address of the center apparatus as 192.168.2.0/24. When a packet is transmitted from the base 101 to WAN3/center 102, the IP address of the center apparatus, which is DstIP, is translated from 192.168.2.0/24 to 192.168.1.0/24, and the IP address of the base apparatus, which is SrcIP, is translated from 192.168.1.0/24 to 192.168.3.0/24.

As a result of this address mapping, the center apparatus identifies the IP address of the base apparatus as 192.168.3.0/24. When a packet is transmitted from the center 102 WAN3 to the base 101, the IP address of the base apparatus, which is the DstIP, is translated from 192.168.3.0/24 to 192.168.1.0/24, and the IP address of the center apparatus, which is SrcIP, is translated from 192.168.1.0/24 to 192.168.2.0/24.

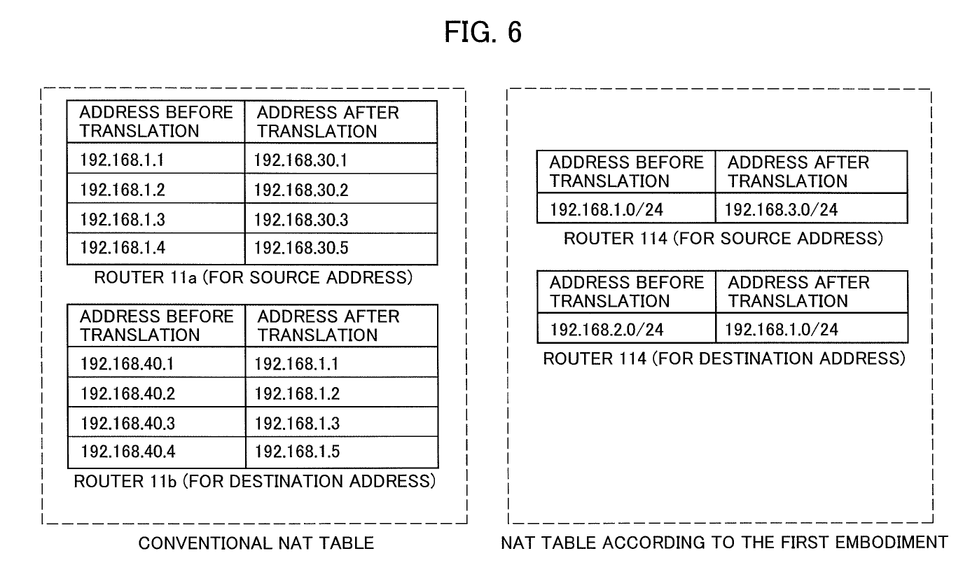

The NAT unit 131 of the router 114 according to this embodiment acquires the above mentioned address mapping from the tunnel server 104, and stores the mapping as a NAT table. FIG. 6 is a table showing a conventional NAT table and a NAT table according to the embodiment of the present invention. The left side of the figure indicates a conventional NAT table, whereas the right side indicates a NAT table according to this embodiment. The conventional NAT table indicates the NAT table for the source address at the router 11a, and that for destination address at the router 11b. In the conventional NAT table, one entry indicates a pair of IP addresses.

The NAT table according to this embodiment indicates the source address range at the router 114, and the destination address range.

When the source and destination addresses (SrcIP and DstIP) fall into an address range before translation, NAT unit 131 of the router 114 according to this embodiment translates these addresses into IP address ranges after translation. For example, when the address range before translation is 192.168.1.0/24 and after translation is 192.168.2.0/24, the high 24 bits are translated while the low 8 bits are not translated. This can reduce the number of entries in the NAT table and storage memory; thereby reducing search time for the table.

Next, operation after the S120 process in the sequence of FIG. 4 is explained.

The client 12 transmits an inquiry on the address of the server 13 to the DNS117a (SrcIP=the base address of the client 12, DstIP=the base address of DNS 117a) (S421). The DNS 117a transfers the address inquiry to the DNS 117b (SrcIP=the base address of DNS117a, DstIP=the global address of the router 115) (S422).

The router 114 performs NAT for the address inquiry (SrcIP=the global address of the router 114, DstIP=the global address of the router 115) (S423), and transfers the address to the router 115 outside a tunnel (S424). The router 115 performs NAT for the address inquiry (SrcIP=the global address of the router 114, DstIP=the center address of DNS117b) (S425), and transfers the address to DNS117b (S426).

As the response, DNS117b transmits the center address of the server 13(192.168.1.1) (SrcIP=the center address of DNS 117b, DstIP=the global address of the router 114) (S431). The router 115 performs NAT for the response (SrcIP=global address of router 115, DstIP=global address of router 114) (S432), and transfers the address to the router 114 outside the tunnel (S433).

Then the router 114 performs NAT for the response (SrcIP=the global address of the router 115, DstIP=base address of DNS117a) (S434), translates the content of the response, translates the center address of the server 13 (192.168.1.1) into the base address (192.168.2.1) (S435), and transfers the base address to the DNS117a (S436). The DNS117a transfers the response to the client 12 (SrcIP=the base address of DNS 117a, DstIP=the base address of the client 12) (S437).

By the above processes, the client 12 identifies the IP address of the server 13 as the base address (192.168.2.1).

Then, the client 12 transmits the data to the server 13 (SrcIP=base address of the client 12 (192.168.1.1), DstIP=base address of the server 13(192.168.2.1)) (S761). The router 114 which received the data performs NAT for the data based on the address mapping (SrcIP=the center address of the client 12 (192.168.3.1), DstIP=center address of the server 13 (192.168.1.1) (S762), applies the tunneling process to the data (encapsulization SrcIP=the global address of the router 114(192.168.30.10), DstIP=global address of the router 115 (192.168.40.10) (S763), and transfers the data to the router 115 through the tunnel (S764).

The router 115 applies the tunneling process to the data (decapsulization: SrcIP=center address of the client 12 (192.168.3.1), DstIP=the center address of the server 13(192.168.1.1) (S765), and transfers the data to the server 13 (S766), which completes this sequence.

As a result of the above process, the server 13 identifies IP address of the client 12 as the center address 192.168.3.1. Thus, thereafter data can be transmitted from the server 13 to the client 12 without any problem.

Next, the operation when no address overlap exists in the tunneling communication system according to this embodiment is explained.

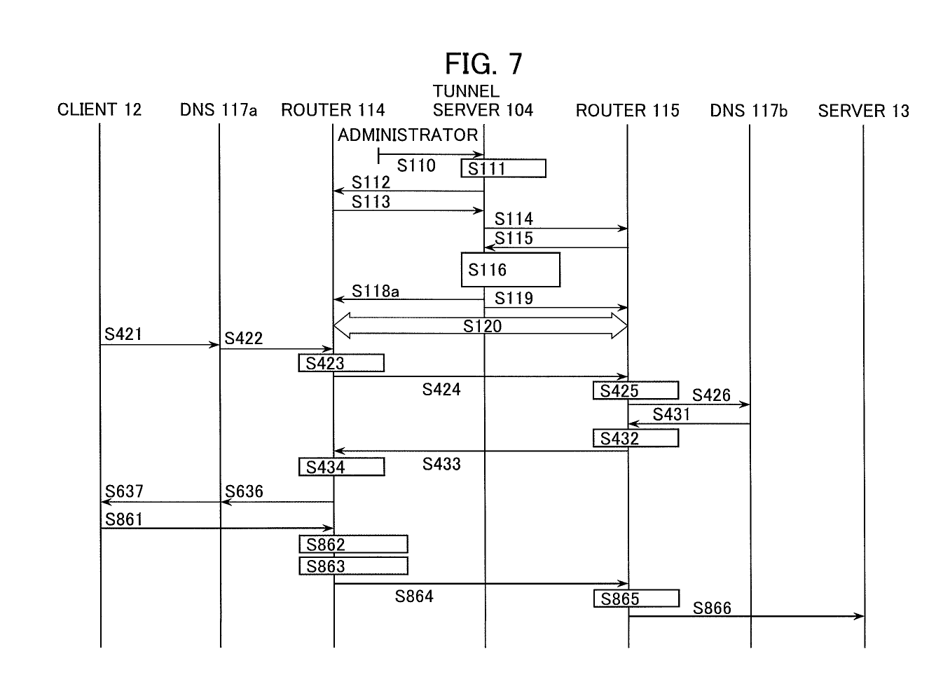

FIG. 7 is a sequence diagram illustrating an operation when no address overlap exists in the tunneling communication system according to the present invention. When a reference numeral in FIG. 7 is the same as that in FIG. 4, the numeral indicates the same or equivalent entity, thus the explanation is omitted here.

The address range of the base apparatus in the base address space is 192.168.1.0/24, and the base address of the client 12 is 192.168.1.1. The address range of the center apparatus in the center address space is 192.168.9.0/24, and the center address of the server 13 is 192.168.9.1.

First, processes from S110 to S116 are performed.

When no address overlap exists in process S116, the tunnel server 104 (the adjusting address unit 122) does not determine the address mapping. At this time, the tunnel server 104 (the setting tunnel unit 125) transmits only an instruction to build a VPN to the router 114 (S118a), and transmits an instruction to build a VPN to the router 115 (S119).

Then processes from S421 to S434 are performed.

After that, the router 114 transmits the response to the DNS 117a without translating the content of the response (the center address of the server 13). The DNS 117a transfers the response to the client 12 (SrcIP=the base address of the DNS117a, DstIP=the base address of the client 12) (S637).

As a result of the above process, the client 12 identifies the IP address of the server 13 as the center address (192.168.9.1), and because no address overlap exists, the address can be treated the same way as the base address.

Next the client 12 transmits the data to the server 13 (SrcIP=the base address of the client 12 (192.168.1.1), DstIP=the center address of the server 13(192.168.9.1)) (S861). The router 114 which received the data performs the tunneling process on the data (encapsulization: SrcIP=global address of the router 114, DstIP=global address of a router 115) (S863) and transfers the data to the router 115 through the tunnel (S864)

The router 115 applies the tunneling process to the data (decapsulization: SrcIP=the base address of the client 12 (192.168.1.1), DstIP=the center address of the server 13(192.168.9.1) (S865), and transfers the data to the server 13 (S866), to complete this sequence.

As a result of the above process, the server 13 identifies the IP address of the client 12 as the base address 192.168.1.1. and because no address overlap exists, it can be treated the same way as a center address. Thus, thereafter the data can be transmitted from the server 13 to the client 12 without any problem.

A second embodiment of the tunneling communication system will now be described.

The configuration of the tunneling communication system in this embodiment is the same as that of the first embodiment, but the tunnel server 104 in this embodiment builds a tunnel dynamically (builds a tunnel every time a session starts).

Next, operation when addresses overlap exists in the tunneling communication system according to this embodiment will be explained.

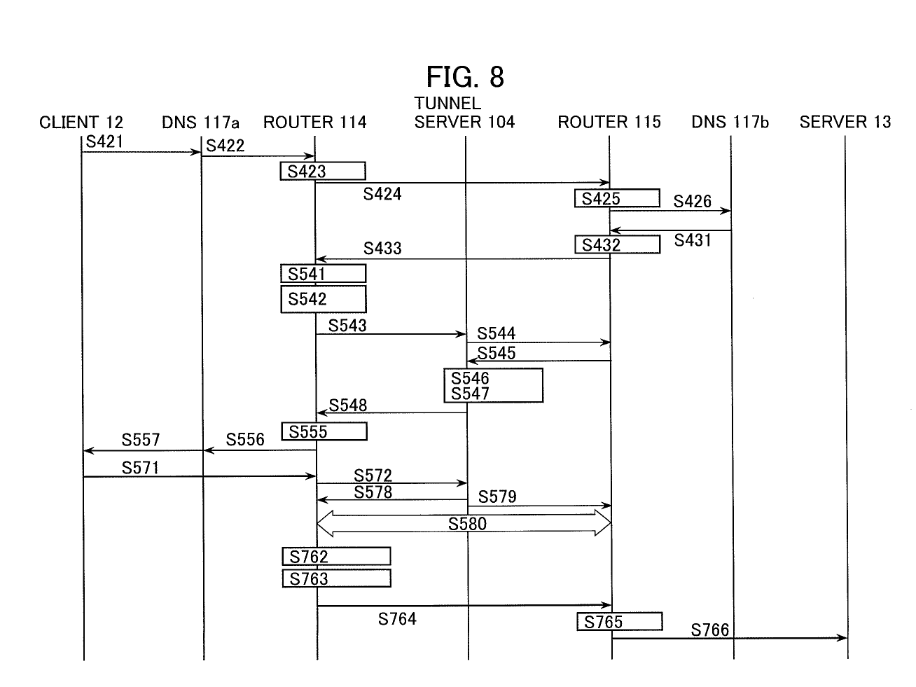

FIG. 8 is a sequence diagram illustrating an operation when address overlap exists in the tunneling communication system according to the embodiment of the present invention. This sequence diagram indicates operations of the client 12, the DNS117a, the router 114, the tunnel server 104, the router 115, the DNS 117b, and the server 13.

First, processes from S421 to S433 according to the first embodiment are performed. Then, the router 114 performs NAT for the response (SrcIP=the global address of the router 115, DstIP=the base address of DNS117a) (S541), and compares the content of the response, which is the center address 192.168.1.1, with the base address space managed by the router 114 itself, and determines whether address overlap exists or not (S542).

When address overlap exists, the router 114 transmits a request for adjusting the address to the tunnel server 104 in order to avoid address overlap between the base 101 where the router 114 belongs, and the center 102 with which the router 114 communicates (S543). The tunnel server 104 (the adjusting address unit 122) transmits an inquiry on private address space to the router 115 (S544).

As the response, the router 115 transmits center address space information (192.168.1.0/24) to the tunnel server 104 (S545). Then the tunnel server 104 (the adjusting address unit 122) compares information on the received base address space with that on the center address space to determine whether address overlap exists or not (S546).

When address overlap exists, the tunnel server 104 (the adjusting address unit 122) determines an address mapping so that no address overlap exists (S547), and transmits the address mapping to the router 114 (S548). Then the router 114 translates the center address of the server 13 (192.168.1.1), which is the content of the response into the base address (192.168.2.1) (S555), and transfers the translated address to the DNS117a (S556). Then the DNS117a transfers the received response to the client 12 (S557).

When no address overlap exists, the router 114 does not transmit a request for adjusting addresses. Then the client 12 transmits the data to the server 13 (SrcIP=the base address of the client 12 (192.168.1.1), DstIP=the base address of the server 13(192.168.2.1)) (S571). The router 114 which received the data transmits a request for building a tunnel to the tunnel server 104 (S572).

The tunnel server 104 (setting NAT unit 126) which received the request for building a tunnel transmits a NAT instruction to the router 114, and the tunnel server 104 (the setting tunneling unit 125) transmits a VPN building instruction to the router 114 (S578). Moreover, the tunnel server 104 (the setting tunneling unit 125) transmits the VPN building instruction to the router 115 (S579). The router 114 and 115 which received the VPN building instruction builds the VPN between the base 101 and the center 102 (S580).

After that, processes from S761 to S766 are performed according to the first embodiment of the present invention, thereby completing the sequence. According to this embodiment, even when a tunnel is built dynamically, the same effect as the first embodiment can be achieved.

A third embodiment of the tunneling communication system according to this invention will now be explained.

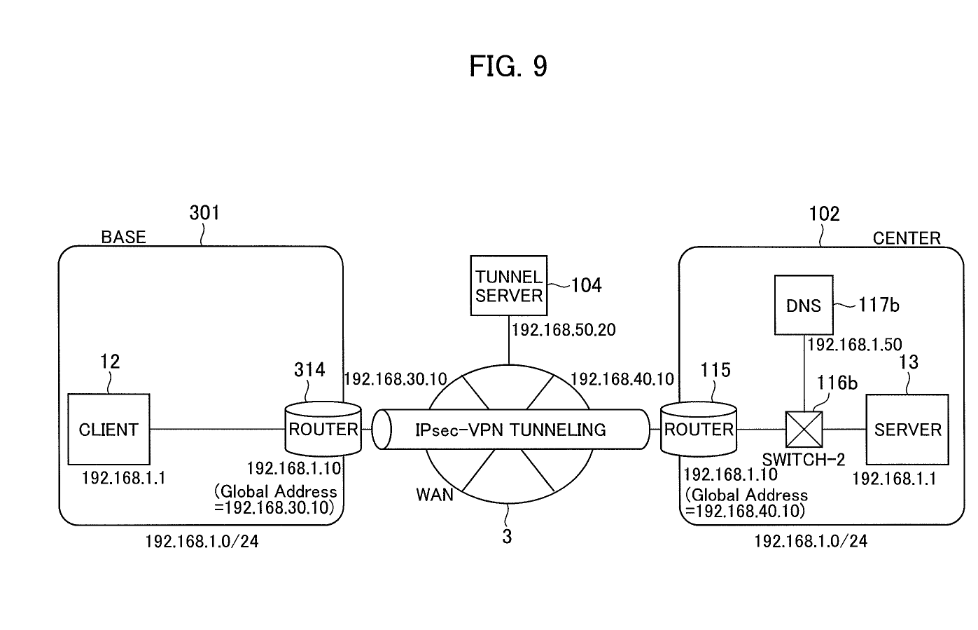

FIG. 9 is a block diagram illustrating a system configuration of the tunneling communication system according to the third embodiment of the present invention. When a reference numeral in FIG. 9 is the same as that in FIG. 1, the numeral indicates the same or equivalent entity, thus the explanation is omitted here. FIG. 9 when compared with FIG. 1 provides the base 301 instead of the base 101. The base 301 when compared with the base 101 has a router 314 instead of the router 114 and does not require a DNS 117a and a switch 116a.

The router 314 provides a function of the DNS117 in addition to the function of the router 114. The tunnel server 104 in this embodiment builds a tunnel statically.

Next, operation when addresses overlap in the tunneling communication system according to this embodiment will be explained.

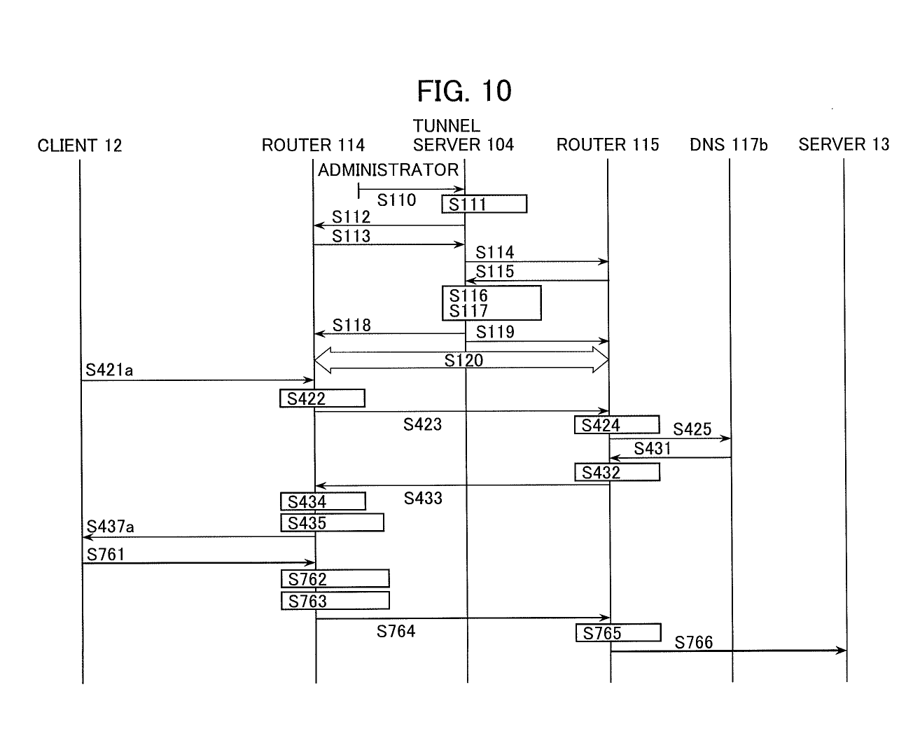

FIG. 10 is a sequence diagram illustrating an operation when address overlap exists in the tunneling communication system according to this embodiment of the present invention. The sequence diagram illustrates operations of the client 12, the router 314, the tunnel server 104, the router 115, DNS117b, and the server 13. When a reference numeral in FIG. 10 is the same as that in FIG. 4, the numeral indicates the same or equivalent entity, thus the explanation is omitted here.

First, processes from S110 to S120 are performed. The router 314 here performs the same operation as that of the router 114 according to the first embodiment of this invention.

Next, instead of processes of S421 and S422 according to the first embodiment, the client 12 transmits an inquiry for the address of the server 13 to a router 314 (SrcIP=the base address of the client 12, DstIP=the base address of the router 314) (S421a).

Then processes from S423, S425 and S431 to S435 according to the first embodiment are performed.

Then the router 314 transfers the response to the client 12 instead of performing processes S436 and S437 according to the first embodiment (SrcIP=the base address of DNS117a, DstIP=the base address of the client 12) (S437a).

After that, processes from S761 to S766 according to the first embodiment of the present invention are performed, which completes the sequence. The router 314 here performs the same operation as that of the router 114 according to the first embodiment of this invention.

According to this embodiment, providing a DNS function to the router reduces communication regarding the DNS, thereby reducing the processing time.

A fourth embodiment of the tunneling communication system according to this invention will now be explained.

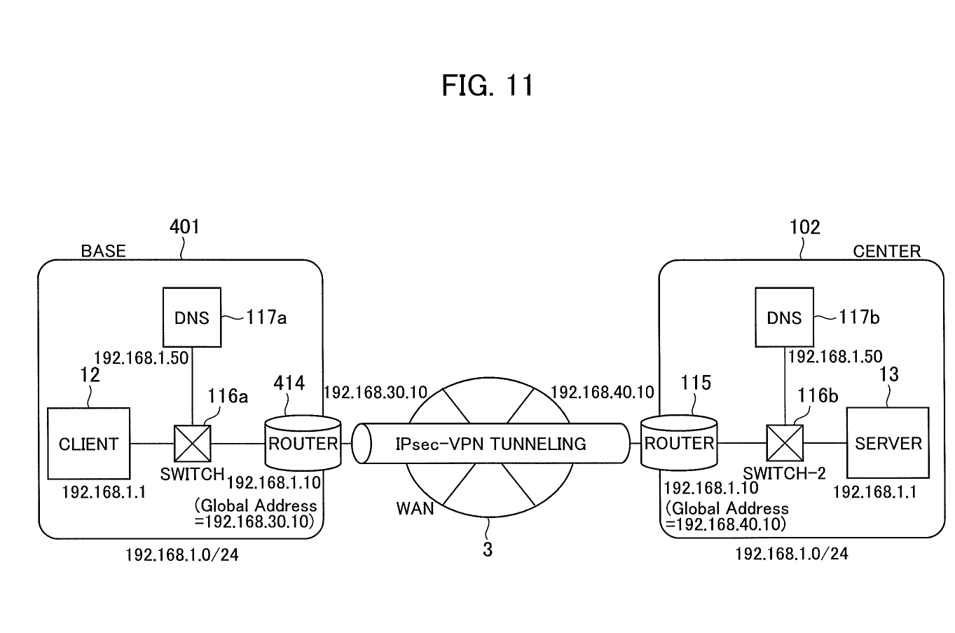

FIG. 11 is a block diagram illustrating a system configuration of the tunneling communication system according to the fourth embodiment of the present invention. When a reference numeral in FIG. 11 is the same as that in FIG. 1, the numeral indicates the same or equivalent entity, so the explanation is omitted here. FIG. 11 when compared with FIG. 1 provides the base 401 instead of the base 101 and does not require a tunnel server 104. The base 401 when compared with the base 101 provides a router 414 instead of the router 114.

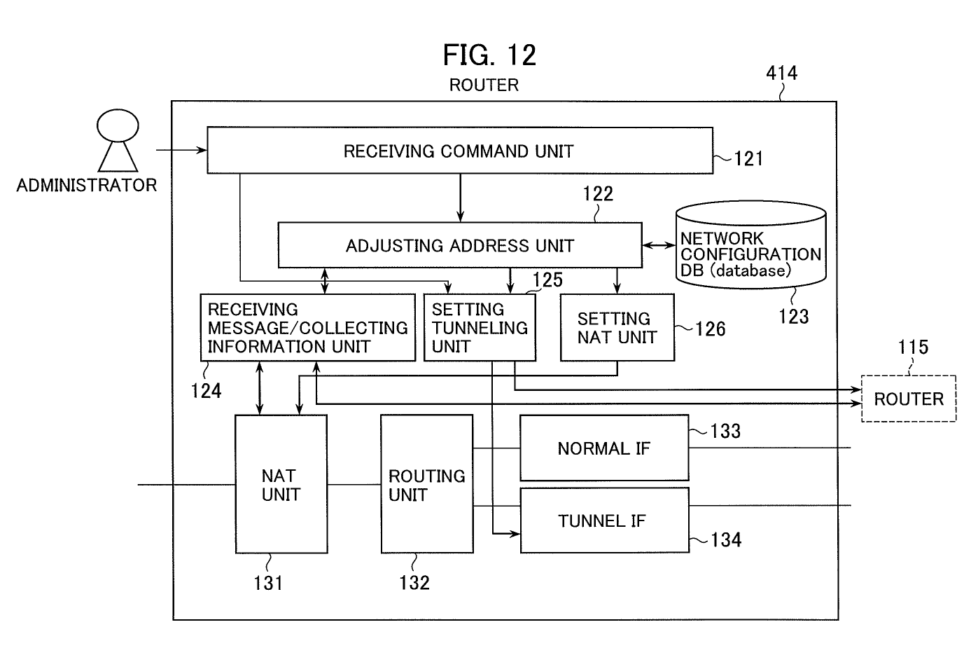

The router 414 according to this embodiment provides a function of the tunnel server 104 in addition to the function of the router 114 of the first embodiment. FIG. 12 is a block diagram illustrating a router configuration according to the embodiment of the present invention. When a reference numeral in FIG. 12 is the same as that in FIG. 2 or FIG. 3, the numeral indicates the same or equivalent entity, thus the explanation is omitted here. FIG. 12, when compared with FIG. 2, has a receiving command unit 121, an adjusting address unit 122, a network configuration DB (database) 123, a receiving message/collecting information unit 124, a setting tunnel unit 125, and a setting NAT unit 126 the same as those of the tunnel server 104.

Next, operation when address overlap exists in the tunneling communication system according to this embodiment will be explained.

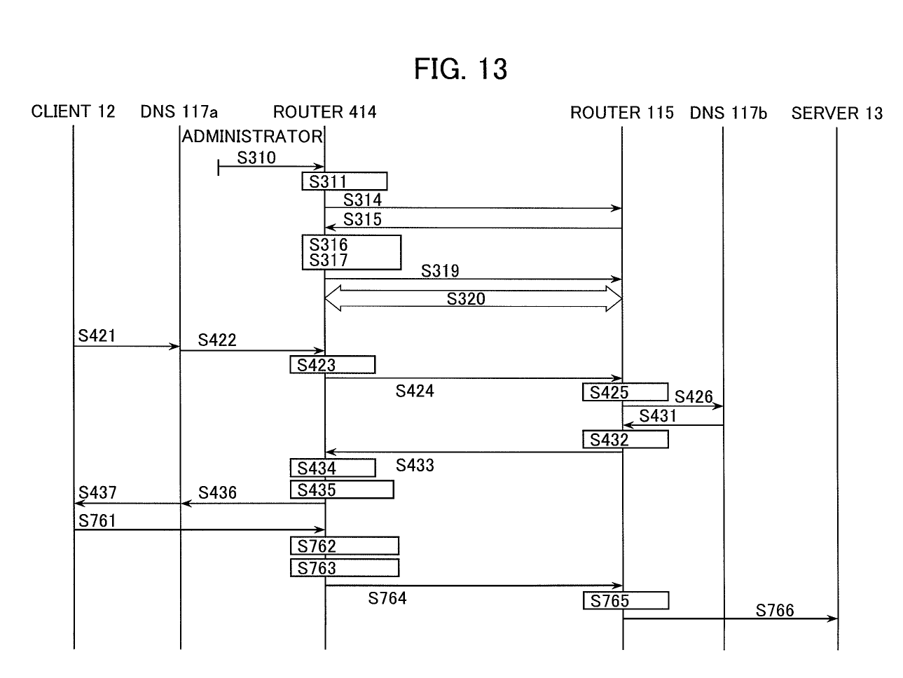

FIG. 13 is a sequence diagram illustrating an operation when address overlap exists in the fourth embodiment. The sequence diagram illustrates operations of the client 12, DNS117a, the router 414, the router 115, the DNS117b, and the server 13. When a reference numeral in FIG. 13 is the same as that in FIG. 4, the numeral indicates the same or equivalent entity, thus the explanation is omitted here.

First, when the router 414 (the receiving command unit 121) receives the tunnel setting from the administrator (S310), it identifies the connection router (S311).

Then, the router 414 (the adjusting address unit 122) transmits an inquiry for private address space to the router 115 (S314). As the response, the router 115 transmits the center address space information to the router 414 (S315). Then the router 414 (the adjusting address unit 122) compares information on received base address space and that on center address space to determine whether or not address overlap exists (S316).

When address overlap exists, the router 414 (the adjusting address unit 122) determines an address mapping so that addresses do not overlap (S317). Then the router 414 (the setting tunnel unit 125) transmits a VPN build instruction to the router 115 (S319). The router 414 and 115 which received the VPN building instruction builds the VPN between the base 101 and the center 102 (S320).

Then, the processes from S421 to S766 similar to the processes of the first embodiment are performed. The router 414 here performs the same operation as that of the router 114 according to the first embodiment of the present invention.

By the above processes, as in the first embodiment, the client 12 identifies the IP address of the server 13 as the base address (192.168.2.1) and the server 13 identifies the IP address of the client 12 as the center address (192.168.3.1). Thereafter, data can be transmitted from the server 13 to the client 12 without any problem.

Next, the operation when no address overlap exists in the tunneling communication system according to this embodiment will be explained.

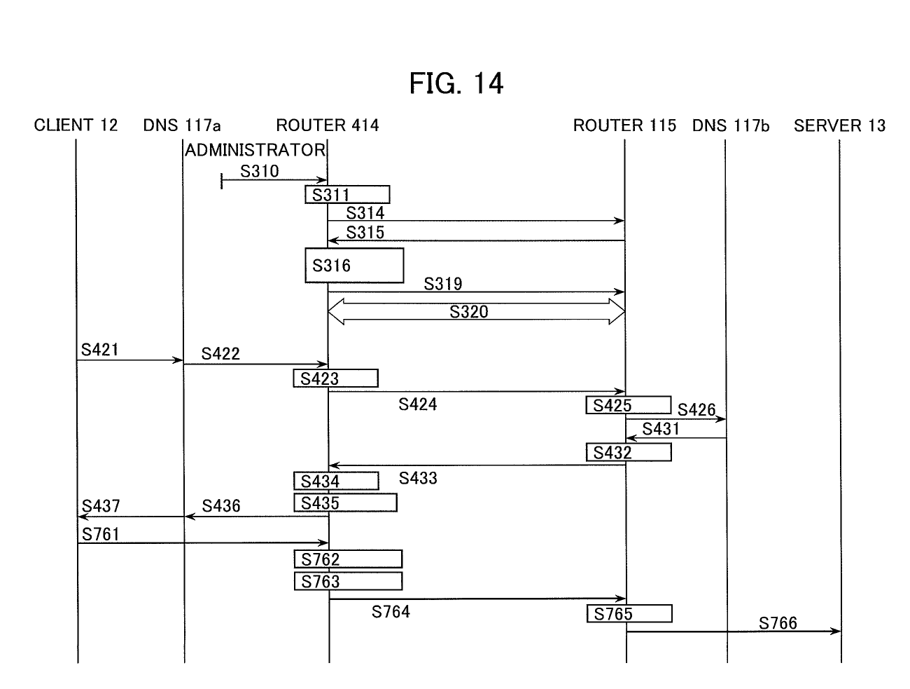

FIG. 14 is a sequence diagram illustrating an operation when no address overlap exists. When a reference numeral in FIG. 14 is the same as that in FIG. 13 or FIG. 7, the numeral indicates the same or equivalent entity, thus the explanation is omitted here.

The address range of the base apparatus in the base address space is 192.168.1.0/24 and the base address of the client 12 is 192.168.1.1. The address range of the center apparatus in the center address space is 192.168.9.0/24, and the center address of the server 13 is 192.168.9.1.

First, processes from S311 to S316 are performed. The router 414 here performs the same operation as that of the router 114 in the first embodiment.

When no address overlap exists in the process S316, the router 414 (the adjusting address unit 122) does not determine the address mapping. At this time, the router 414 (the setting tunnel unit 125) transmits an instruction to build a VPN to the router 115 (S319). The router 414 and 115 which received the VPN building instruction builds the VPN between the base 101 and the center 102 (S320).

Next processes from S421 to S766 according to the first embodiment are performed. The router 414 here performs the same operation as that of the router 114 according to the first embodiment of this invention.

Through the above processes, the client 12 identifies the IP address of the server 13 as the center address (192.168.9.1) and because no address overlap exists, the address can be treated the same way as the base address. The server 13 identifies the IP address of the client 12 as the base address (192.168.1.1), and because no address overlap exists, the address can be treated the same way as the center address. Thus, thereafter data can be transmitted from the server 13 to the client 12 without any problem.

In each of the above mentioned embodiments, the router in each base performs a NAT. A configuration in which a router in the center performs a NAT is allowed as well. According to each of the above mentioned embodiments, there is no need to prepare global addresses for every client and server. Moreover, performing NAT by a router either in the base or in the center can prevent overlap of private addresses.

In the Claims, the acquiring step corresponds to processes from S112 to S115 according to the embodiment. The judging step corresponds to the process S116, and the determining step corresponds to the process S117. The setting step corresponds to the process S118, and the translating step corresponds to the processes S435 and S762. The building step corresponds to the processes S118 and S120.

In other claims, an acquiring unit, a judging unit, and a determining unit correspond to the adjusting address unit in the embodiment. The setting unit corresponds to the NAT setting unit according to the embodiment. The translating unit corresponds to the router in the embodiment, and a building unit corresponds to the setting tunnel.

Moreover, a program that causes a computer in network relay apparatus to execute the above mentioned steps can be provided as a network relay control program. The program causes the computer to execute the program by storing the program in media readable and run by the computer. Media readable by a computer includes an internal memory internally mounted to a computer such as ROM or RAM, a portable memory such as CD-ROM, a flexible disk, DVD disk, a magnet-optical disk, and IC card, and a database which stores computer programs, or another computer, and database on the other computer, and transmission media on a network as well.

What is claimed is:

1. A storage medium storing a network relay control program that causes a computer to perform tunneling communication between a first network and a second network, the program stored in the storage media causing the computer to execute:
acquiring a first address range which is a private address range within a first network from a relay apparatus within the first network and a second address range which is a private address range within the second network from a relay apparatus within the second network; and
determining whether the acquired first and second address ranges are overlapped or not and when the first and the second address ranges are determined to be overlapped, then determining a third address range and a fourth address range by avoiding overlapping of the first, the third and the fourth address ranges, wherein the third address range is a private address used by a communication device within the first network to identify a communication device within the second network and the fourth address range is a private address used by a communication device within the second network to identify a communication device within the first network, and avoiding overlap of the second, the third, and the fourth address ranges as well and setting translation of a packet for the tunneling communication between the first and the third address ranges, and the second and the fourth address ranges based on the determined third and fourth address ranges.

2. The storage medium storing a network relay control program according to claim 1, wherein the program further causes a computer to execute the following processes;
translation between said first address range and said third address range, such that said second and said fourth address ranges are set either to a router in the first network or the second network.

3. The storage medium storing a network relay control program according to claim 2, wherein the program further causes a computer to execute the following processes;
translation between said first and said third address ranges, such that said second and said fourth address ranges are performed by network address translation (NAT).

4. The storage medium storing a network relay control program according to claim 3, wherein the program further causes a computer to execute the following processes;
determine the third address range and the fourth address range for an area within the predetermined private address range other than said first and said second address ranges.

5. The storage medium storing a network relay control program according to claim 1, wherein the program further causes a computer to execute the following processes;
after said setting step, translating between the first and the third address ranges and between the second address range and the fourth address range for a packet of said tunneling communication based on the instruction by said setting step.

6. A network relay apparatus for performing tunneling communication between a first network and a second network comprising;
an acquiring unit acquiring a first address range which is a private address range within the first network from a relay apparatus within the first network, and a second address range which is a private address range within the second network from a relay apparatus within the second network,
a judging unit judging whether the first and the second address ranges acquired by said acquiring unit are overlapped or not,
when said judging unit determines that the first and second addresses overlap, a determining unit determining a third address range and a fourth address range by avoiding overlap of the first, the third and the fourth address ranges, wherein the third address range is a private address range used by a communication device within the first network to identify a communication device within the second network and the fourth address range is a private address range used by a communication device within the second network to identify a communication device within the first network; and
a setting unit setting translation of a packet for the tunneling communication between the first and the third address ranges, and setting that between the second and the fourth address ranges based on the determination by said determining unit.

7. A network relay control apparatus according to claim 6 further comprising:
said setting unit sets translation between said first and said third address ranges, and that between a second address range and a fourth address range either to a router in said first network or to a router in said second network.

8. A network relay control apparatus according to claim 7 wherein translation between said first and said third address ranges and that between said second and said fourth address ranges are performed by a NAT.

9. A network relay control apparatus according to claim 8 wherein the third address range and the fourth address range are located in an area within a predetermined private address range other than said first and said second address ranges.

10. A network relay control apparatus according to claim 6 comprising a translating unit that translates a packet for said tunneling communication between the first and the third address ranges and that between the second address range and the fourth address ranges based on the instruction by said setting unit for a packet of said tunneling communication.

11. A network relay control apparatus according to claim 10 wherein said translating unit further translates said second address range from the first network into the fourth address range based on the instruction by said setting unit.

12. A network relay control apparatus according to claim 10 wherein said translating unit further encapsulates or decapsulates a packet for said tunneling communication.

13. A network relay control apparatus according to claim 6 wherein said acquiring unit inquires said private address range at least either to said first network or said second network.

14. A network relay control method performed by a computer for controlling relay control of tunneling communication between a first and a second network comprising:
acquiring a first address range which is a private address range within the first network from a relay apparatus within the first network and a second address range which is a private address range within the second network from a relay apparatus within the second network;
judging whether or not the acquired first and second address ranges are overlapped, and
when the two address ranges are judged to be overlapped, then determining a third address range and a fourth address range as follows;
avoiding overlap of the first, the third and the fourth address ranges, wherein the third address range, which is a private address range, is used by a communication device within the first network to identify a communication device within the second network, and the fourth address range, which is a private address range, is used by a communication device within the second network to identify a communication device within the first network, and avoiding overlap of the second, the third, and the fourth address ranges as well, and
setting translation of a packet for the tunneling communication between the first and the third address ranges, and that between the second and the fourth address ranges based on the determined third and fourth address ranges.
